(19) United States
(12) Patent Application Publication
(10) Pub. No.: US 2010/0083531 A1
(43) Pub. Date: Apr. 8, 2010

(54) SAFE CLOTHES DRYING MACHINE WITH A LARGE SPACE STRUCTURE

(76) Inventor: Jiebo Hu, Zhejiang (CN)

Correspondence Address: DAVID AND RAYMOND PATENT FIRM, 108 N. YNEZ AVE., SUITE 128, MONTEREY PARK, CA, 91754, US

(21) Appl. No.: 12/449,993

(22) PCT Filed: Feb. 19, 2008
(86) PCT No.: PCT/CN2008/000366

§ 371 Date: Sep. 3, 2009

(30) Foreign Application Priority Data
Apr. 5, 2007 (CN) 200710090731.X

(51) Int. Cl. F26B 21/06; F26B 25/06

(52) U.S. Cl. 34/565; 34/218

(57) ABSTRACT

A clothes drying machine, particularly a safe clothes drying machine with a large space structure is disclosed. It includes a clothes drying chamber, a warm air buffer chamber, a fan chamber for heat supply and a controller, wherein the clothes drying chamber, warm air buffer chamber and fan chamber for heat supply are independent parts assembled in turn from top down, and the warm air buffer chamber disposed under the clothes drying chamber is a basin-shaped casing with an opening upwards and an air inlet attached to the fan chamber for heat supply is disposed at the bottom of the basin-shaped casing is provided with a fixing device for clothes drying chamber. The clothes drying chamber according to the present invention is consisted of six elements, that is to say, a barrel-shaped cloth cover, a top bracket for supporting the barrel-shaped cloth cover, a basin-shaped casing making up warm wind buffer chamber, support pieces pinned to the basin-shaped casing and circumference edges of the top bracket, a fan chamber for heat supply as well as bottom support legs. Its advantages exist in large space, safety for use, simple structure and convenience to disassemble, transport and install. It will only take a little time for the consumers to finish installation.

### BACKGROUND OF THE PRESENT INVENTION

1. Field of Invention

The present invention relates to a warm air exhaust clothes drying machine, and more particularly to a safe clothes drying machine with a large space structure using a sealing cover made of soft material, wherein the heat source is located at the bottom of the sealing cover while the water vapor is exhausted at the top of the sealing cover.

2. Description of Related Arts

From the time humanity invented clothes, clothes became a part of human civilization. Modern, civilized humans view the washing of various types of clothes with importance. In today's homes, electronic drying machines for drying washed clothes are in the forms of barrel-shaped dedicated drying machine and composite machines for both washing and drying. However, such products produce wrinkles in the dried clothes and damage the clothes. In addition, the prices of the machines fall between $1000 and $10000. Such a price range only matches the needs of a high income fraction of the population and is out of the reach of a broad salary range. A cabinet type clothes drying machine made of surrounding panels (metallic boards, composite boards, and glass boards) also appeared on the market, but because the structure is complex, the size is large, and the transport volume is large, the cost of the machine is high, and its price is around $125. For the average consumer, the price is still too high.

In recent years, those skilled in the art developed a simple cloth covered warm air exhaust clothes drying machine. There is competition to develop a wave of low-priced, novel, and scientific clothe drying tools to meet the needs of the people.

The following clothes drying machines were found through a patent search:

China patent CN98234374.4 disclosed a clothes drying machine.

China patents CN99226450.2 and 99226450.2 disclosed a rapid clothes drying cabinet.

China patent CN02272023.5 disclosed a clothes drying machine.

China patent CN200420014883.3 a warm air clothes drying machine.

The common features of the above disclosed clothes drying machines are:

1. The connecting column for the inside of the clothes drying chamber is in the form of a central column-type primary pole. A top bracket is connected to the top of the primary pole. The bottom of the primary pole is slipped into the center of the exhaust mechanism at the bottom. The bottom surface of the exhaust plate has a plurality of support pieces to suspendedly support the whole body of the clothes drying machine.

2. The cloth cover for preventing leakage of warm air is made of a heat resistant and soft material. A zipper for adding and removing clothes is disposed at the front of the cloth cover. The advantages of such a covering are low cost of manufacture, excellent ability to prevent leakage of warm air, and convenience of use.

3. Warm air is blow through the exhaust plate at the bottom of the central support column. The warm air rises into the clothes drying chamber. Such a structure takes full advantage of the physical phenomenon of the rising of warm air and benefits the drying of clothes.

However, the following disadvantages exist:

1. As disclosed in CN02272023.5 and CN20040014883.3, the exhaust port is around the bottom of the primary pole. A person skilled in the art knows through analysis or use that the temperature just outside the exhaust port is high. If a user uses a clothes drying machine of such a structure to dry long clothes, the bottom of the clothes will be close to the exhaust port, and the high temperature current from the exhaust port will damage the clothes and cause the user to sustain losses.

2. Using the above exhaust port structure for a clothes drying machine, if a large article of clothing slides from the hanger during use of the machine, and the article of clothing falls on the central exhaust port and blocks the port, then the high temperature current is concentrated at the exhaust plate, burning the article of clothing and possibly causing a fire.

3. A central column-shaped primary pole connects to the top bracket for hanging clothes at the top and to the middle of the exhaust mechanism at the bottom, thus connecting the main parts of the interior of the clothes drying chamber. Such a structure takes space in the interior, rendering the hanging of clothes inconvenient. Also, the support offered by a single central column is poor. If clothes are hung on a single side, then it is easy to lose balance and harm the machine. In addition, the placement of the central column support in the middle of the exhaust mechanism causes the high temperature exhaust to heat the bottom of the column, leading to hazards during use.

Application CN200610109222.2, titled “A Cabinet-type Clothes Drying Machine” (illustrated in FIG. 1) and by the present inventor, discloses a cabinet-type clothes drying machine, wherein warm air buffer chamber partitioning board 16 forms warm air buffer chamber 15 above warm air tunnel protection board 14, and humidity probe 12 and temperature probe 13 are used to calibrate the temperature and humidity controlling heater for the warm air buffering chamber and the clothes drying chamber. Because the cabinet-type clothes drying machine comprises a warm air buffering chamber partitioning board 16 disposed above the warm air tunnel protection board 14 and a temperature probe 12, the invention solves the problems of damaging the dried clothing and the high temperature current damaging articles of clothing and causing a fire in the case of an article of clothing falling onto the exhaust port. The features are: 1. The warm air buffering chamber is made of a cloth cover, and the straight support columns are supported by the bottom casing. 2. The structure is relatively complex, and installation is complex. 3. The current generator is on one side of the bottom casing, and the cross section for current flowing from the air tunnel is limited. In other words, part of the space is occupied by the current generator, and there is some positional bias in the air in the warm air buffering chamber, creating a low temperature section above the current generator in the warm air buffering chamber and the clothes drying chamber and high temperature sections above the openings for current flow.

Application CN200620018906.7 by the present inventor discloses a tent-shaped clothes drying machine (illustrated in FIG. 2), comprising support bracket 6 and heater 1 mounted on support bracket 6. An arch-shaped exhaust dome 2 is mounted at the top of the heater 1. A lower support pipe 5 is connected to the trough axis of the arch-shaped exhaust dome 2, and an upper support pipe 4 is connected to the lower support pipe 5. The features are: Current guiding flakes 3 are evenly disposed around exhaust port 9 of the arch-shaped exhaust dome, a waterproof cover 10 is disposed on the arch-shaped exhaust dome and below the lower support pipe 5, and the bottom of the support bracket 6 comprises integral support legs 7, each support leg 7 having a wheel 8. The current guiding flakes in the invention successfully guide the warm air and improve the current flow. The warm air current does not cascade horizontally but flow upward, thus achieving excellent drying with low energy expenditure. Heat resistant and low heat-conducting plastic current guiding flakes remain within safe temperatures during use, firmly support the support pipes, and does not allow conduct the high temperature from the exhaust dome to the upper support pipe. The wheels allow movement of the clothes drying machine and provide convenience. The upper support pipe and the lower support pipes are connected via a screw mechanism, allowing for easy storage. The tent-shaped clothes drying machine has a low price, $25 each, and falls within the consumptive powers of the general population. However, the safety of the machine is inferior. The same problem of high temperature current damaging the clothing exists. The important problems are: 1. The outer perimeter surrounding the warm air exhaust port is made of a cloth cover, but the cloth cover has low rigidity. During use, a child who inadvertently displaces the cloth cover may be burned. 2. There is a column in the middle of the clothes drying chamber that occupies room in the clothes drying chamber, introducing difficulties in hanging large articles of clothing and leaving cooling clothes.

### SUMMARY OF THE PRESENT INVENTION

A main object of the present invention to solve the above problems in the prior art by providing a safe clothes drying machine with a large space structure.

The safe clothes drying machine with a large space structure is practiced as follows:

A safe clothes drying machine with a large space structure, comprises a clothes drying chamber, a warm air buffer chamber, a fan chamber for heated air generator and controller, wherein the clothes drying chamber, warm air buffer chamber, and fan chamber are independent parts arranged in a top to bottom manner.

According to the safe clothes drying machine with a large space structure, the warm air buffer chamber is a basin-shaped casing with a top opening and is disposed below the clothes drying chamber. An air inlet for connecting to the fan chamber for generating heated air is disposed at the bottom of the basin-shaped casing. A current guide safety cover is disposed at the top opening of the basin-shaped casing. A securing mechanism for securing the clothes drying chamber is disposed at the top opening of the basin-shaped casing.

According to the safe clothes drying machine with a large space structure, the basin-shaped casing of the warm air buffer chamber is made by injection mold plastic or stretched metal, wherein the surrounding wall is connected to the bottom wall in an arc shaped structure; and a plurality of cup shaped or flake shaped reinforcement ribs are disposed around the outer perimeter of the casing, or the surrounding walls and bottom wall of the casing are configured in a protruded-indented structure.

According to the safe clothes drying machine with a large space structure, wherein the clothes drying chamber comprises a barrel-shaped cloth cover, a top bracket for supporting the barrel-shaped cloth cover, and a supporting assembly for supporting the top bracket. The top bracket is formed by a perimeter bracket and a rack bracket mounted on the perimeter bracket. The perimeter bracket forms the framework of the clothes drying chamber by connecting to the securing mechanism via the supporting assembly. The barrel-shaped cloth cover comprises exhaust holes formed at the top surface, and flexible airtight barrel walls, wherein the barrel-shaped cloth cover is disposed on the framework of the clothes drying chamber.

According to the safe clothes drying machine with a large space structure, the supporting assembly comprises a plurality of support poles, wherein the bottom of the perimeter bracket of the top bracket and the top opening of the basin-shaped casing has a plurality of matching attachment holes, and the support poles are inserted into the matching attachment holes on the bottom of the perimeter bracket of the top bracket and the top opening of the basin-shaped casing.

Or, the supporting assembly comprises a plurality of support pipes, wherein the securing mechanisms on the bottom of the perimeter bracket of the top bracket and the top opening of the basin-shaped casing are evenly disposed matching protrusion pillars, and the support pipe are fixed to the protrusion pillars on the bottom of the perimeter bracket of the top bracket and the top opening of the basin-shaped casing to form the framework of the clothes drying chamber.

Or, the supporting assembly comprises a plurality of support rows, wherein the support rows are formed of two support poles or support pipes with connecting poles or pipes between, the connecting poles or pipes having a horizontal or triangular configuration. The support pole or pipe has a plurality of indented slots for supporting the cloth hanger.

Or, the supporting assembly comprises a plurality of support boards, wherein the securing mechanism on the bottom of the perimeter bracket of the top bracket and the top opening of the basin-shaped casing is a groove or sideways screws. The support boards are securing to the top bracket and the basin-shaped casing through the groove or screws, forming the framework of the clothes drying chamber.

At least two attachment holes or protrusion pillars are on the bottom of the perimeter bracket and the top opening of the basin-shaped casing, and at least two of the support poles or support pipes are provided correspondingly.

According to the safe clothes drying machine with a large space structure, a circumferential outwardly protruding ring is disposed around the top opening of the basin-shaped casing. A tightening mechanism is disposed at the bottom of the barrel-shaped cloth cover. The bottom of the barrel-shaped cloth cover is set on the circumferential outwardly protruding ring around the top opening of the basin-shaped casing and sealed to the top opening of the basin-shaped casing through the tightening mechanism, and a pulling lock is installed on one side of the barrel-shaped cloth cover, thus forming the clothes drying chamber.

According to the safe clothes drying machine with a large space structure, the fan chamber for generating heated air is disposed on the bottom exterior of the basin-shaped casing of the fan chamber for generating heated air. The air inlet on the bottom of the basin-shaped casting is optimally placed in the middle of the bottom of the casing. The fan chamber for generating heated air comprises a fan, a heat-resistant exhaust canopy disposed on the outer shell of the fan, a heating element between the exhaust canopy and the fan, and a filter placed in the shell of the fan corresponding to the position of the blades of the fan.

According to the safe clothes drying machine with a large space structure, an exhaust canopy or exhaust grating is disposed on the air inlet at the bottom of the basin-shaped casing. A water guarding protruding ring is disposed around the bottom canopy of the basin-shaped casing, and water drains are disposed at the bottom of the basin-shaped casing away from the canopy, so as to drain water from the machine after hanging clothes from the washing machine in the clothes drying chamber.

According to the safe clothes drying machine with a large space structure, the exhaust canopy, which is a column-shaped horizontal exhaust canopy, protrudes from the bottom of the casing, wherein the column-shaped horizontal exhaust canopy has a cylindrical shaped body with a sealed top and a plurality of exhaust ports formed at the surrounding wall of the body. Each exhaust port has a horizontal current guiding board. Or the exhaust canopy is a hemispherical exhaust canopy, wherein the hemispherical shell of the exhaust canopy having multiple horizontal, vertical, or spiral exhaust ports. A current guiding board having a corresponding shape is provided at each exhaust port. An umbrella-shaped water guard is provided at the top side of the exhaust canopy, the umbrella-shaped water guard has an outer diameter slightly larger than the projection of the exhaust canopy.

According to the safe clothes drying machine with a large space structure, the exhaust canopy is a grating disposed on the air inlet at the bottom of the casing.

According to the safe clothes drying machine with a large space structure, the current guide safety cover is made of a heat-resistant plastic or metal board, the current guide safety cover having a plurality of fine ventilating holes evenly distributed on the surface, the ventilating holes having an area of 0.5 mm² to 100 mm². The ratio area of the ventilating holes to the area of the current guide safety cover is 1:20 to 1:0.5. The current guide safety cover is affixed to the top opening of the basin-shaped casing by a pressure ring or screws. Or, protrusions are disposed on the inner wall of the basin-shaped casing, wherein the current guide safety cover is affixed to the protrusions on the inner wall of the basin-shaped casing by a pressure ring or screws. The ventilating holes evenly distributed on the surface of the current guide safety cover. Or, the current guide safety cover has a non-holed zone, i.e. the area corresponding to the exhaust canopy is a non-holed zone, with a water channel disposed around the non-holed zone under the current guide safety cover. The non-holed zone and water channel have an outer diameter slightly larger than the projection of the exhaust canopy so as to prevent the water dripped from the clothes in the clothes drying chamber from flowing into the fan chamber for generating heat.

The safe clothes drying machine with a large space structure further comprises a plurality of support legs disposed circumferentially under the basin-shaped casing of the warm air buffer chamber, wherein the support legs are sufficiently long enough to suspendedly support the fan chamber for generating heated air above ground. Each of the support legs has a leg wheel at an end. The support legs are surrounded by a holed planer skirt or further comprise a plurality of integral support legs disposed below the fan, each support leg having a leg wheel.

The safe clothes drying machine with a large space structure further comprises a humidity probe located inside the clothes drying chamber and a temperature probe located inside the warm air buffer chamber, wherein the humidity probe and the temperature probe are electrically connected to the controller.

According to the safe clothes drying machine with a large space structure, the basin-shaped casing of the warm air buffer chamber is made of an air-tight double walled basin-shaped casing made of plastic or metal plating.

The advantages of the present invention are the followings.

1. The clothes drying chamber of the present invention is formed by a barrel-shaped cloth cover, a top bracket supporting the barrel-shaped cloth cover, a basin-shaped casing forming the warm air buffer chamber, a supporting assembly connecting the basin-shaped casing and the perimeter of the top bracket, a fan chamber for generating heated air, and bottom support legs. The structure is simple; it is easy to disassemble, transport, and install; and the consumer may install the machine in a small amount of time.

2. Because the top bracket and the basin-shaped casing of the warm air buffer chamber are integral, the structure is stable and strong, the cost of manufacture is low, and the speed of manufacture is fast. The plurality of support poles or support legs offers good support for the weight of hanged clothes.

3. The warm air buffer chamber formed by the open top basin-shaped casing and the current guide safety cover on the top opening provides the maximum area of even warm current and dry clothes hanged in any position.

4. A plurality of ventilating holes is disposed on the current guide safety cover. The current guide safety cover blocks the continuously emitted warm air from the exhaust canopy. Guided by the horizontal current guiding boards on the exhaust canopy, most of the warm air follows the horizontal current guiding boards' direction and temporarily flow toward the perimeter of the warm air buffer chamber, thus mixing with the cooler air in the warm air buffer chamber and distributing the molecules with higher and lower kinetic energy. As a result, the high temperature air from the fan chamber for generating heated air mixes in this large space to form a clothes drying warm air within usable temperatures. A temperature probe is installed in the warm air buffer chamber or the clothes drying chamber to control the temperature of the warm air buffer chamber or the clothes drying chamber. The temperature probe is connected to a temperature modulator, which controls the electrical current flow to an electrical heating element. Thus, the temperature in the warm air buffer chamber under the current guide safety cover is evenly regulated. This temperature-regulated warm air is separated by the small holes on the current guide safety cover, which increases the quality of clothes drying.

5. There are two installation positions for the temperature probe: The first is near the perimeter of the warm air buffer chamber in order to detect the temperature of the air entering the clothes drying chamber. The other is at the current guiding safety cover in order to detect the temperature of the air flowing into the clothes drying chamber to directly control the temperature of the air flowing into the clothes drying chamber and provide the user with the ability to control the temperature used for clothes of a variety of materials.

6. The fan is installed outside of the warm air buffer chamber, effectively separating the warm air buffer chamber and the fan chamber for generating heated air, thus preventing the warm air from the warm air buffer chamber from affecting the electrical components inside the fan.

7. The temperature probe is installed in the warm air buffer chamber or the clothes drying chamber to measure the local temperature and transmit the measurement to the controller to start or stop the heating element in the fan chamber for generating heated air, thus regulating the temperature in the warm air buffer chamber or the clothes drying chamber. The humidity probe is installed in the clothes drying chamber and transmits data to the controller. The clothes drying machine is automatically controlled and is, safe, energy efficient, fast, accurately controlled, and stops when clothes are dry. The machine satisfies the need for high quality home electronics.

8. The walls of the warm air buffer chamber are insulating materials of a certain thickness, within the chamber is installed a temperature probe, and the temperature of the warm air is regulated within a safe temperature range. If during use, a child inadvertently touches the warm air buffer chamber or the safety board above the chamber, he will not be burned by high temperature current emitted from an exhaust port. When clothes fall onto and cover the safety cover board, the warm air buffer chamber will not damage the clothes because of the temperature probe. Because the safety cover is connected to the casing, if the machine is tipped over to a horizontal position, clothes will not block the exhaust ports.

9. The clothes drying machine of the present invention has a clear assembly method and unique structure. It is stable, strong, scientific, and safe. It is easy to manufacture and easy to package. The price of the machine is appropriate for the average consumer and is suitable for propagation.

These and other objectives, features, and advantages of the present invention will become apparent from the following detailed description, the accompanying drawings, and the appended claims.

### BRIEF DESCRIPTION OF THE DRAWINGS

FIG. 1 is a perspective view illustrating the conventional clothes drying machine with a cloth cover.

FIG. 2 is a perspective view illustrating the conventional cabinet-type clothes drying machine with a cloth cover.

FIG. 3 is a schematic view of a safe clothes drying machine with a large space structure according to a preferred embodiment of the present invention.

FIG. 4 is a sectional view illustrating the cross sectional shape of the basing-shaped casing according to the above preferred embodiment of the present invention.

FIG. 5 is a sectional view illustrating the shape of the top bracket according to the above preferred embodiment of the present invention.

FIG. 6 is a perspective view of the current guide safety cover without a water guarding zone disposed in the top opening of the basin-shaped casing of the warm air buffering chamber according to the above preferred embodiment of the present invention.

FIG. 7 is a perspective view of the current guide safety cover with a water guarding zone disposed on the top opening of the basin-shaped casing of the warm air buffering chamber according to the above preferred embodiment of the present invention.

FIG. 8 is a perspective view of the current guide safety cover without a water guarding zone disposed on the top opening of the basin-shaped casing of the warm air buffering chamber according to the above preferred embodiment of the present invention.

FIG. 9 is a schematic view illustrating a plurality of bottom support legs disposed around the perimeter of the bottom of the basin-shaped casing of the warm air buffering chamber and the current guide safety cover disposed within the basin-shaped casing according to the above preferred embodiment of the present invention.

FIG. 10 is a schematic view of the basin-shaped casing of a warm air buffer chamber, the basin-shaped casing having a holed planer skirt and a plurality of support legs below according to the above preferred embodiment of the present invention.

FIG. 11 is a schematic view of a support row connecting the top bracket and the basin-shaped casing according to the above preferred embodiment of the present invention.

FIG. 12 illustrates an alternative mode of the support row connecting the top bracket and the basin-shaped casing according to the above preferred embodiment of the present invention.

FIG. 13 a schematic view of a flake shaped connecting board connecting a pair of support poles or support pipes according to the above preferred embodiment of the present invention.

FIG. 14 is a schematic view of the support board according to the above preferred embodiment of the present invention.

FIG. 15 is schematic view illustrating a hemispherical exhaust canopy according to the above preferred embodiment of the present invention.

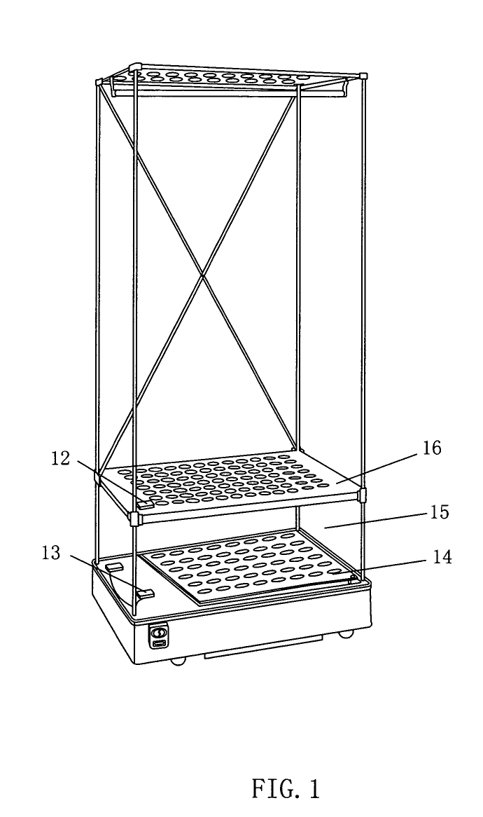

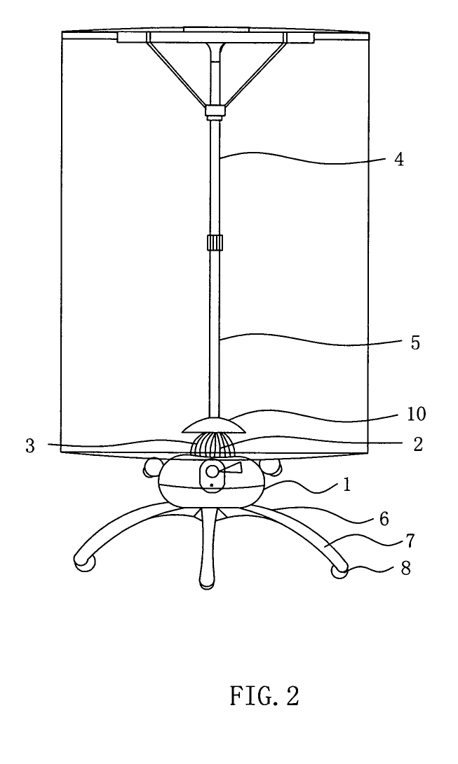

### DETAILED DESCRIPTION OF THE PREFERRED EMBODIMENT

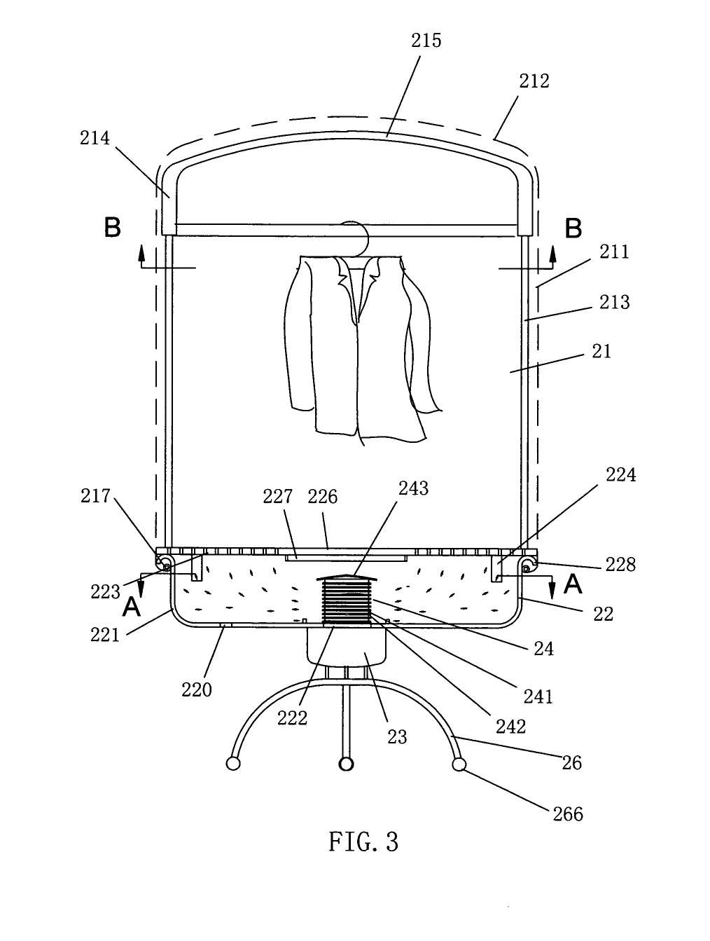

Referring to FIG. 3 of the drawings, a safe clothes drying machine with a large space structure according to a preferred embodiment of the present invention is illustrated, wherein the safe clothes drying machine comprises a clothes drying chamber 21, a warm air buffer chamber 22, a fan chamber 23 for heated air generator and controller, wherein the clothes drying chamber 21, warm air buffer chamber 22, and fan chamber 23 are independent parts of the machine and are arranged in a top to bottom manner. The warm air buffer chamber 22 is a basin-shaped casing 221 with a top opening and is disposed below the clothes drying chamber 21. The cross sectional area of the basin-shaped casing 221 matches with the cross sectional area of the clothes drying chamber 21. An air inlet 222 is disposed at the bottom of the basin-shaped casing 221 for connecting to the fan chamber 23 for generating heated air. A current guide safety cover 223 is disposed at the top opening of the basin-shaped casing 221. A securing mechanism, which comprises a plurality of installation holes or protrusion pillars 224 as shown in FIG. 4, for securing the clothes drying chamber 21 is disposed at the top opening of the basin-shaped casing 221.

The basin-shaped casing 221 of the warm air buffer chamber 22 is made by injection mold plastic or stretched metal, wherein the surrounding wall is connected to the bottom wall in an arc shaped structure to prevent any dead air zone within the basin-shaped casing 221 when the warm air is circulating therewithin, so as to enhance the warm air being evenly distributed within the basin-shaped casing 221. A plurality of cup shaped or flake shaped reinforcement ribs are disposed around the outer perimeter of the casing, or the surrounding walls and bottom wall of the casing are configured in a protruded-indented structure, so as to strengthen the overall structure of the basin-shaped casing 221 and improve its efficiency.

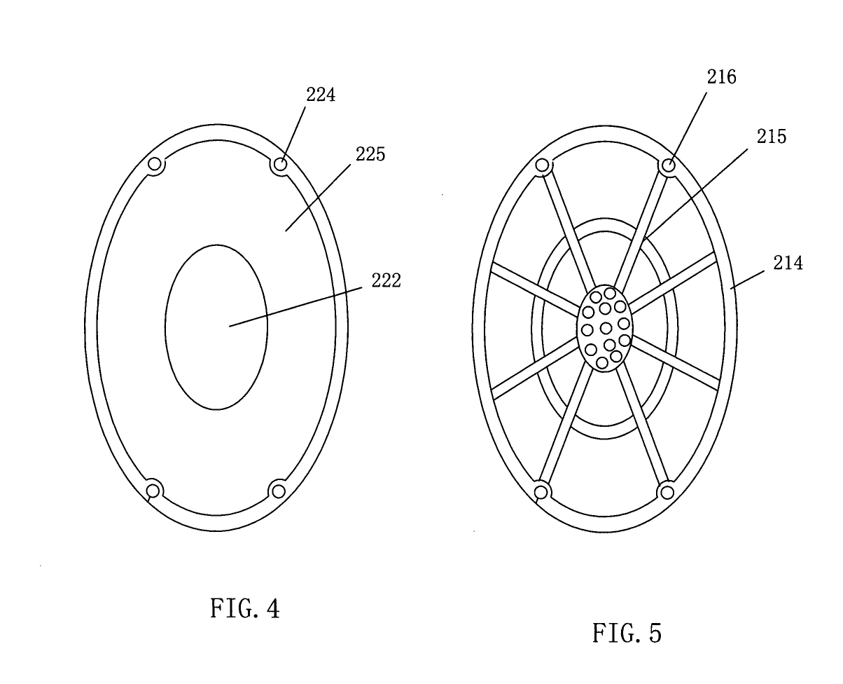

The clothes drying chamber 21 comprises a barrel-shaped cloth cover 211, a top bracket 212 for supporting the barrel-shaped cloth cover 211, and a supporting assembly 213 for supporting the top bracket 212 at its periphery. The supporting assembly 213 comprises a plurality of support poles, support pipes, or the like. The clothes drying chamber 21 is defined at a space between the current guide safety cover 223 and the top bracket 212. The top bracket 212 is formed by a perimeter bracket 214 and a rack bracket 215 mounted on the perimeter bracket 214, as shown in FIGS. 3 and 5. A plurality of protrusion pillars 224, or installation holes, are evenly formed at the bottom of the perimeter bracket 214 of the top bracket 212 corresponding to the top opening of the basin-shaped casing 221, wherein the support poles or support pipes 224 are affixed to the protrusion pillars 224 on the bottom of the perimeter bracket 214 of the top bracket 212 and the top opening of the basin-shaped casing 221 to form the framework of the clothes drying chamber 21. The barrel-shaped cloth cover 211 comprises exhaust holes formed at the top surface, and flexible airtight barrel wall, wherein the barrel-shaped cloth cover 211 is disposed on and supported by the framework of the clothes drying chamber 21. A tightening mechanism 217 is disposed at the bottom of the barrel-shaped cloth cover 211. A pulling lock (not shown in the figure) is provided on one side of the barrel-shaped cloth cover 211, wherein the barrel-shaped cloth cover 211 is supported by the top bracket 212 at a position that the top side of the barrel-shaped cloth cover 211 matches with the top bracket 212 while the barrel wall is dropped down from the top bracket 212 to form the clothes drying chamber 21 The bottom opening of the barrel-shaped cloth cover 211 is sealed and tightened at the top side of the warm air buffer chamber 22 via the tightening mechanism 217.

In order to seal and tighten the bottom opening of the barrel-shaped cloth cover 211 at the top side of the warm air buffer chamber 22, a circumferential outwardly protruding ring 228 is formed at the bottom of the barrel-shaped cloth cover 211. The bottom opening of the barrel-shaped cloth cover 211 can envelop with the protruding ring 228. Accordingly, the length of the barrel wall of the barrel-shaped cloth cover 211 is long enough to envelop with the protruding ring 228 when the barrel wall is dropped down from the top bracket 212. Therefore, the tightening mechanism 217 can be operated to seal and tighten the bottom opening of the barrel-shaped cloth cover 211 at the top side of the warm air buffer chamber 22, so as to form an entrance of the clothes drying chamber 21 for placing the clothes therein or taking the clothes out. Preferably, there are two different types of the tightening mechanism 217. The first type thereof is rope type that a rope sleeve is provided at the bottom opening of the barrel-shaped cloth cover 211 such that a rope is slidably passing along the rope sleeve. Therefore, when two ends of the rope are pulled and tied, the bottom opening of the barrel-shaped cloth cover 211 is shrunk to tighten at the warm air buffer chamber 22. The second type of the tightening mechanism 217 is elastic rope type that an elastic rope is provided at the bottom opening of the barrel-shaped cloth cover 211 to secure at the warm air buffer chamber 22 by the elastic force.

At least two attachment holes or protrusion pillars 216 are on the bottom of the perimeter bracket 214 and the top opening of the basin-shaped casing 221, and at least two of the support poles or support pipes are provided correspondingly. The support poles or support pipes are coupled with the attachment holes or protrusion pillars 216 at the perimeter bracket 214 and top opening of the basin-shaped casing 221.

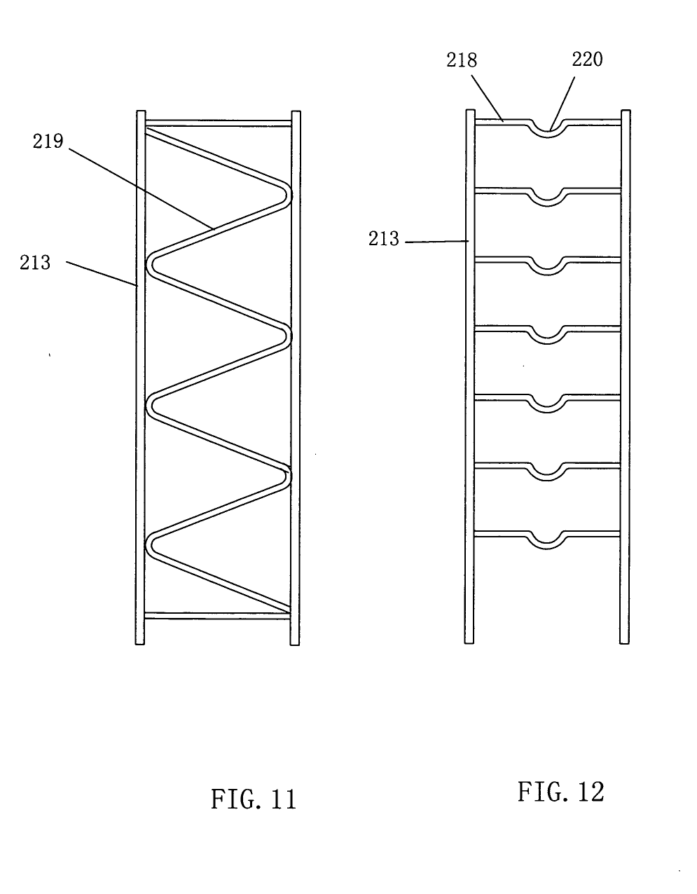

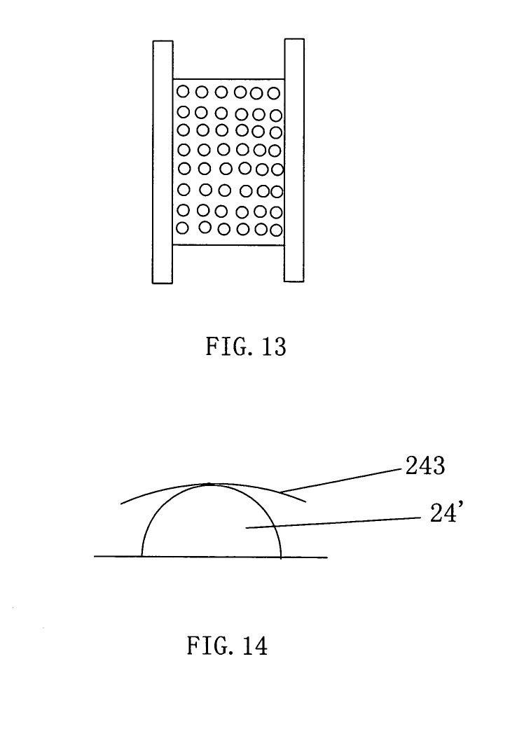

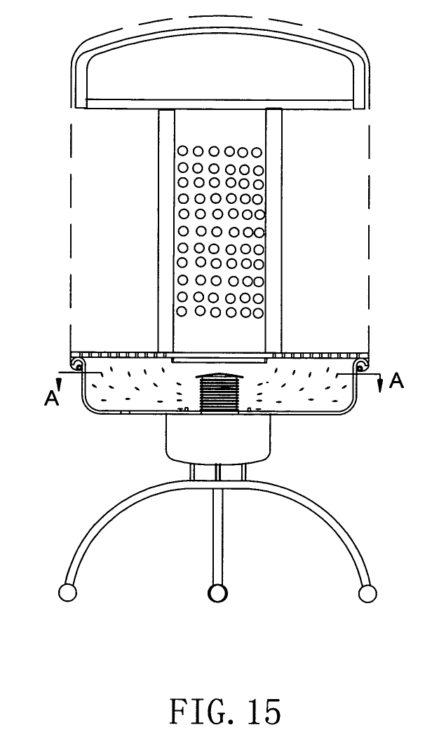

When the safe clothes drying machine is designed for small capacity use (such as only one or two clothes replacement in hotel), the support poles or support pipes can be made for parallel strengthen support, wherein the machine is only need to support by two parallel support or just one strengthen to fulfill the top bracket 212, as shown in FIG. 15. The zipper door can make bigger. After the user open the zipper door, the operation space for them to place or take out their clothes has become much flexible. Preferably, there are two types of support enhancement to strength the support of the support poles or support pipes. The first one is that a plurality of connecting poles or pipes are formed between two support poles or support pipes to form a support row. Each of the connecting poles has a horizontal configuration 218 as shown in FIG. 12 or triangular configuration 219 as shown in FIG. 11. The support pole or pipe with the horizontal configuration 218 has a plurality of indented slots 220 for supporting the cloth hanger. Accordingly, each of the connecting poles with the horizontal configuration 218 or the triangular configuration 219 is coupled between the support poles or support pipes preferably by welding to form the support row. Another type of support enhancement is that using plate shape metal plate or plate shape plastic plate as the combination of the support poles or support pipes as shown in FIGS. 13 and 15.

The shape of the perimeter bracket 214 and the opening of the basin-shaped casing 221, i.e. the cross section of the clothes drying chamber 21, can be made in round shape, oval-shape, square shape, rectangular shape, or the combination of the round and rectangular shape.

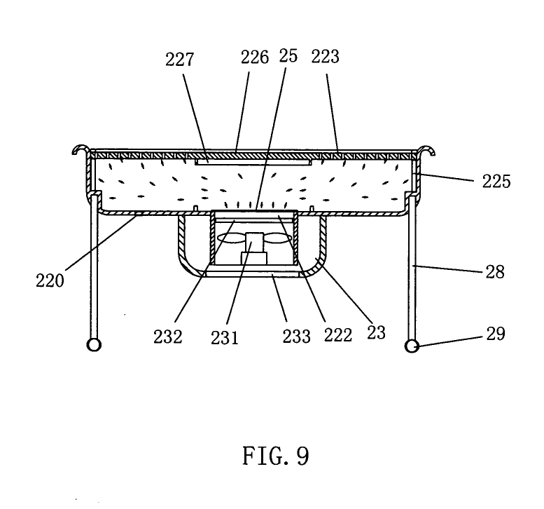

As shown in FIG. 9, the fan chamber 23 comprises a fan 231, a heat-resistant exhaust canopy 24 disposed on the outer shell of the fan 213 as shown in FIG. 3, a heating element 232 between the exhaust canopy 24 and the fan 231, and a filter 233 placed in the shell of the fan 231 corresponding to the position of the blades of the fan 231. The fan chamber 23 is disposed on the bottom exterior of the basin-shaped casing 221 by the following two methods. The first method is that the casing of the fan chamber 23 is made by injection mold plastic or stretched metal, or metal pressure-filled method, wherein the interior components is installed into the fan chamber 23 through the opening thereof or through the air inlet of the fan chamber 23 such that the inlet door can be coupled at the air inlet after the interior components are installed into the fan chamber 23. Another method is that the fan chamber 23 is coupled with the air inlet 222 via screws, wherein the air inlet 22 on is optimally placed in the middle of the bottom of the basin-shaped casting such that the warm air can be evenly distributed at the fan chamber 23.

A sealing ring is provided between the fan chamber 23 and the basin-shaped casing to prevent the warm air being leaked out from the fan chamber 23. Moreover, it further, prevents the warm air leaking out the fan chamber 23 to cause overheat of the body of the machine. The fan chamber 23 further comprises a control unit connecting with en electrical outlet.

An exhaust canopy 24 or exhaust grating 25 is disposed on the air inlet 222 at the bottom of the basin-shaped casing. A water guarding protruding ring 229 is disposed around the bottom canopy 24 of the basin-shaped casing, and water drains 200 are disposed at the bottom of the basin-shaped casing away from the canopy 24, so as to drain water from the machine after hanging clothes from the washing machine in the clothes drying chamber.

There are preferably three different types of exhaust canopy 24. The first type of exhaust canopy 24, which is a column-shaped horizontal exhaust canopy, protrudes from the bottom of the casing, wherein the column-shaped horizontal exhaust canopy 24 has a cylindrical shaped body with a sealed top and a plurality of exhaust ports 241 formed at the surrounding wall of the body. Each exhaust port has a horizontal current guiding board. A current guiding board having a corresponding shape is provided at each exhaust port 241 to guide the air flowing between every two of the current guiding board. The top side of the column-shaped horizontal exhaust canopy 24 is air-sealed such that when the warm air flows from the fan chamber 23 vertically towards the column-shaped horizontal exhaust canopy 24, the warm air will bound to change its direction to form a horizontal warm air. Each layer of the column-shaped horizontal exhaust canopy 24 has at least one exhaust port 241 such that the warm air flows to the column-shaped horizontal exhaust canopy 24, the column-shaped horizontal exhaust canopy 24 can evenly distribute the warm air. Accordingly, the warm air is guided to spread out in a horizontal direction at 360° to evenly distribute around the warm air buffer chamber 22 in an air circulating manner.

The air is guided to flow to 360 horizon direction to full with the warm air buffer chamber 22 such that it is beneficial to produce even distribution hot air and good air circulation within the air buffer chamber 22. Therefore, the warm air is capable of reaching every area of the clothes drying chamber 21 to warm the air therewithin so as to achieve the better efficiency of cloth drying.

The second type of the exhaust canopy 24′ is a hemispherical exhaust canopy, as shown in FIG. 14, wherein the hemispherical shell of the exhaust canopy 24′ has multiple horizontal, vertical, or spiral exhaust ports. A current guiding board having a corresponding shape is provided at each exhaust port. The hemispherical shell of the exhaust canopy 24′ guides the warm air flowing out in a radial manner. An umbrella-shaped water guard 243 is provided at the top side of the exhaust canopy 24′, wherein the umbrella-shaped water guard 243 has an outer diameter slightly larger than the projection of the exhaust canopy 24′. The third type of the exhaust canopy is a grating 25 disposed on the air inlet 22 at the bottom of the casing, wherein the grating 25 can be either protruded or not protruded from the bottom of the casing.

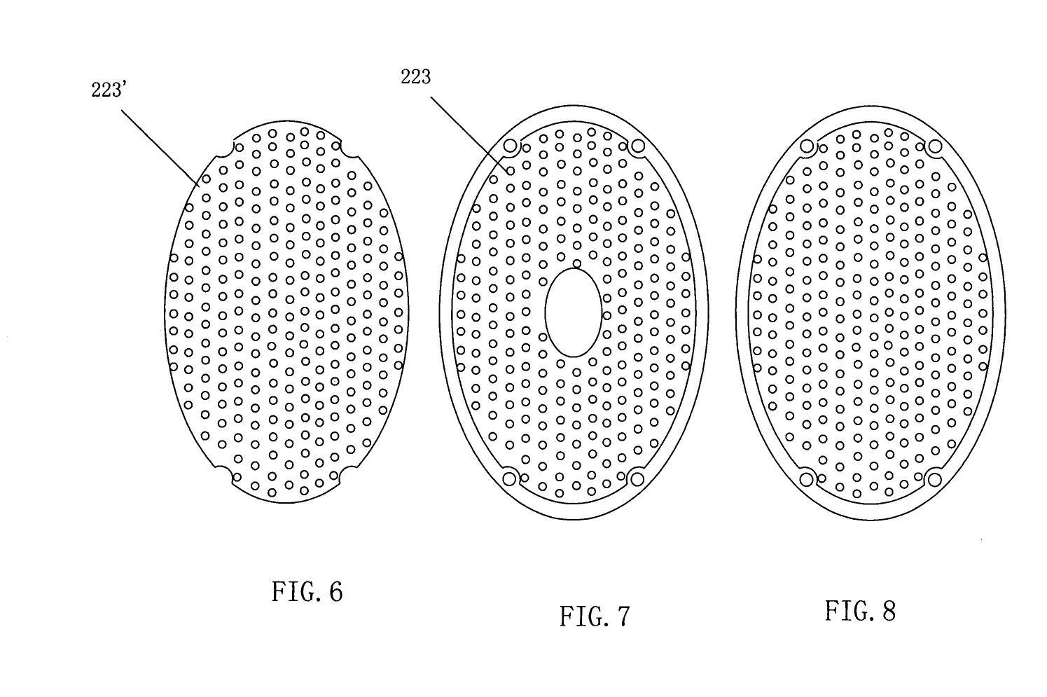

The current guide safety cover 223 is made of a heat-resistant plastic or metal board, wherein the current guide safety cover 223 has a plurality of fine ventilating holes evenly distributed on the surface. The ventilating holes have an area of 0.5 mm² to 100 mm². The ratio area of the ventilating holes to the area of the current guide safety cover is 1:20 to 1:0.5. Preferably, there are two installation methods for the current guide safety cover 223. The first installation method is that the current guide safety cover 223 is affixed to the top opening of the basin-shaped casing by a pressure ring or screws, as shown in FIGS. 7 and 8. The second installation method is that protrusions 225 are disposed on the inner wall of the basin-shaped casing, wherein the current guide safety cover 223 is affixed to the protrusions 225 on the inner wall of the basin-shaped casing by a pressure ring or screws, as shown in FIG. 9. Preferably, there are two configurations of the ventilating holes. The first configuration is that the ventilating holes are evenly distributed on the surface of the current guide safety cover 223, as shown in FIGS. 6 and 8. The second configuration is that the current guide safety cover 223 has a non-holed zone 226, i.e. the area corresponding to the exhaust canopy is a non-holed zone, as shown in FIGS. 3 and 7, with a water channel 227 disposed around the non-holed zone 226 under the current guide safety cover 223. The non-holed zone 226 and water channel 227 have an outer diameter slightly larger than the projection of the exhaust canopy 24, wherein the exhaust canopy 24 comprises a sealing ring to prevent the water dripped from the exhaust canopy 24 into the fan chamber 23.

In other words, the machine of the present invention prevents the water dripped from the clothes in the clothes drying chamber 21 to the fan chamber 23 by two structures. The first structure is that the current guide safety cover 224 provides the non-holed zone 226 and the water channel 227 disposed around the non-holed zone 226 under the current guide safety cover 223. The non-holed zone 226 and water channel 227 have an outer diameter slightly larger than the projection of the exhaust canopy so as to prevent the water dripped from the clothes in the clothes drying chamber 21 from flowing into the fan chamber 23, so as to prevent the heat generator in the fan chamber 23 from being damaged. The second structure is that the umbrella-shaped water guard 243 is provided at the top side of the exhaust canopy 24′, wherein the umbrella-shaped water guard 243 has an outer diameter slightly larger than the projection of the exhaust canopy 24′.

Therefore, by forming the umbrella-shaped water guard 243 is provided at the top side of the exhaust canopy 24′, the warm air will detour by the umbrella-shaped water guard 243 to prevent the warm air from directly flowing to the current guide safety cover 223 and the clothes drying chamber 21. In other words, the warm air is guided to flow horizontally by the umbrella-shaped water guard 243 to produce even distribution warm air and good air circulation within the air buffer chamber 22. Therefore, the warm air is capable of reaching every area of the clothes drying chamber 21 to warm the air therewithin so as to achieve the better efficiency of cloth drying.

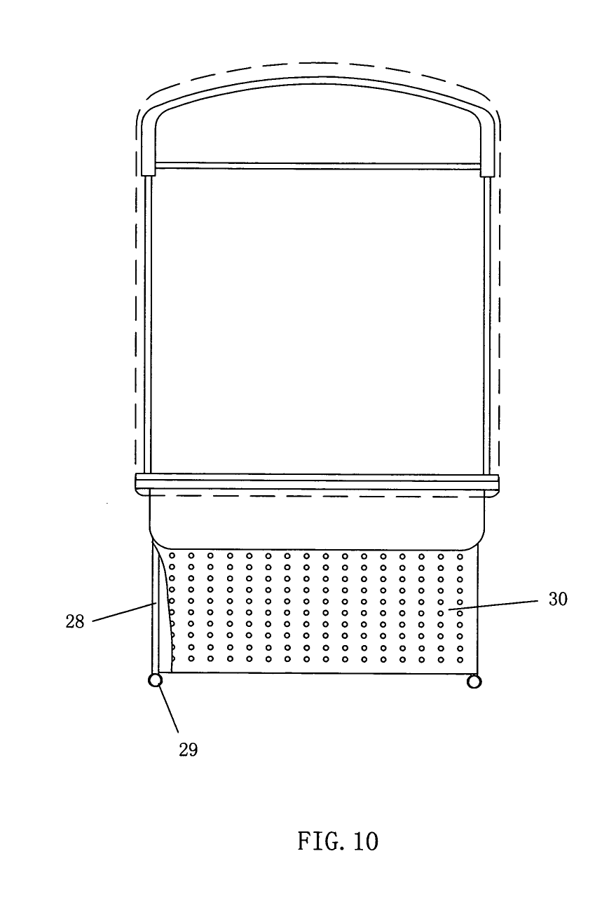

There are two types of support legs for the machine. The first type is that at least three support legs 28 disposed circumferentially under the basin-shaped casing of the warm air buffer chamber 22, wherein the vertical portions of the support legs 28 are slidably inserted into the bottom peripheral edge of the warm air buffer chamber 22. Accordingly, the support legs 28 are sufficiently long enough to suspendedly support the fan chamber 23 for generating heated air above ground. Each of the support legs 28 has a leg wheel 29 at an end. The support legs 28 are surrounded by a holed planer skirt 30, as shown in FIG. 10, wherein the holed planer skirt 30 forms as a net shaped panel. The second type is that the support legs 26 are extended below the fan via screws, each support leg 26 having a leg wheel 266.

The holed planer skirt 30 has the following two advantages. The holed planer skirt 30 highly improves the efficiency of the machine. Another one is to prevent the shredded paper or the plastic bag falling at the air inlet of the fan so as to prevent the shredded paper or the plastic bag blocking the filter by means of suction force. In other words, if the shredded paper or the plastic bag is stunk at the air inlet of the fan, the air is unable to enter into the air inlet to cause the overheat or abnormal operation of the fan. It is worth mentioning that the through holes at the holed planer skirt 30 enables the air entering to the air inlet of the fan. After the holed planer skirt 30 is installed, the power switch is formed in a box shape and is put inside the holed planer skirt 30 or the outer side wall of the casing.

The first type of the basin-shaped casing with at least three support legs 28 provides a good support of the casing without limiting the size thereof. The second type of support leg 26 is good for supporting a relatively small size of casing that fits for one to five clothes therein. Because the casing has smaller size and lighter weight, it is much appropriate for connecting to the support leg 26.

The two above mentioned types of support legs 28, 26 can evenly distribute the weight of the machine.

The safe clothes drying machine further comprises a humidity probe located inside the warm air buffer chamber 22 or a temperature probe located inside the clothes drying chamber 21, wherein the humidity probe and the temperature probe are electrically connected to the controller. When the humidity is lower than the preset value, the controller can be automatically turned off. In other words, when the clothing is dried, the machine will automatically turn off to achieve the goal of energy saving and much safety.

Moreover, there are two different structures for locating the air inlet and the fan. The first structure is that the air inlet is located at the peripheral edge of the casing at the bottom thereof. The second structure is that the air inlet is located at the sidewall of the casing. The two above mentioned structures can provide a better air guiding configuration for guiding the air flowing far away from the air outlet. Since the location of the air exit is relocated, the position of the support leg will be correspondingly changed. The first type of the support leg can be remained the same that the support legs are disposed circumferentially under the basin-shaped casing of the warm air buffer chamber 22. The second type of the support leg will be altered that the support legs are extended at the center or the center portion of the basin-shaped casing.

Accordingly, the basin-shaped casing made of plastic or metal to form a single wall structure. Therefore, the warm air can easily transmit through the wall of the warm air buffer chamber 22. In order to achieve a better energy saving and safety purpose, the basin-shaped casing of the warm air buffer chamber 22 is made of plastic or metal to form a double walled structure that air is filled between the double walled structure as a heat insulation layer for minimizing the heat loss within the basin-shaped casing through the wall thereof. There are two advantages of having the double walled structure: one is to reduce the energy waste, and another one is to always keep outer surface of the basin-shaped casing at low temperature for safety purpose.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A safe clothes drying machine with a large space structure, comprising: a clothes drying chamber, a warm air buffer chamber, a fan chamber for heat generation and controller, wherein said clothes drying chamber, said warm air buffer chamber, and said fan chamber are independent with each other and are arranged in a top to bottom manner.

2. The safe clothes drying machine, as recited in claim 1, wherein said warm air buffer chamber is a basin-shaped casing with a top opening and is disposed below said clothes drying chamber, wherein an air inlet is provided at the bottom of said basin-shaped casing to connect to said fan chamber for generating heated air, wherein a current guide safety cover is disposed at said top opening of said basin-shaped casing, and a securing mechanism is disposed at said top opening of the basin-shaped casing for securing said clothes drying chamber.

3. The safe clothes drying machine, as recited in claim 2, wherein said basin-shaped casing of said warm air buffer chamber is made of injection mold plastic or stretched metal, wherein a surrounding wall is connected to a bottom wall with an arc shaped configuration; and a plurality of cup shaped or flake shaped reinforcement ribs are disposed around an outer perimeter of said casing, or said surrounding wall and said bottom wall of said casing are configured in a protruded-indented structure.

4. The safe clothes drying machine, as recited in claim 1, wherein said clothes drying chamber comprises a barrel-shaped cloth cover, a top bracket for supporting said barrel-shaped cloth cover, and a supporting assembly for supporting said top bracket, wherein said top bracket is formed by a perimeter bracket and a rack bracket mounted on said perimeter bracket, said perimeter bracket forming a framework of said clothes drying chamber by connecting to a securing mechanism via said supporting assembly; wherein said barrel-shaped cloth cover comprises exhaust holes at the top surface and flexible airtight barrel walls, said barrel-shaped cloth cover being disposed on said framework of said clothes drying chamber.

5. The safe clothes drying machine, as recited in claim 4, wherein said supporting assembly comprises a plurality of support poles, the bottom of said perimeter bracket of said top bracket and said top opening of said basin-shaped casing has a plurality of matching attachment holes, wherein said support poles are inserted into the matching attachment holes on the bottom of said perimeter bracket of said top bracket and said top opening of said basin-shaped casing; or
wherein said supporting assembly comprises a plurality of support pipes, a plurality of corresponding protrusion pillars are evenly provided at said securing mechanisms on the bottom of said perimeter bracket of said top bracket and said top opening of the basin-shaped casing, wherein said support pipes are affixed to said protrusion pillars on the bottom of said perimeter bracket of said top bracket and the top opening of said basin-shaped casing to form said framework of said clothes drying chamber; or
wherein said supporting assembly comprises a plurality of support rows, said support rows being formed of two support poles or support pipes with connecting poles or pipes between, said connecting poles or pipes having a horizontal or triangular configuration, wherein said support pole or pipe has a plurality of indented slots for supporting a cloth hanger; or
wherein said supporting assembly comprises a plurality of support boards, said securing mechanism on the bottom of said perimeter bracket of said top bracket and said top opening of the basin-shaped casing is a groove or sideways screws, wherein said support boards are securing to said top bracket and said basin-shaped casing through said groove or screws, forming said framework of said clothes drying chamber;
wherein at least two said attachment holes or protrusion pillars are provided on the bottom of said perimeter bracket and said top opening basin-shaped casing, and at least two said support poles or support pipes are provided correspondingly.

6. The safe clothes drying machine, as recited in claim 1, wherein a circumferential outwardly protruding ring is disposed around the top opening of said basin-shaped casing, wherein a tightening mechanism is disposed at the bottom of said barrel-shaped cloth cover, wherein the bottom of said barrel-shaped cloth cover is set on said circumferential outwardly protruding ring around the top opening of said basin-shaped casing and sealed to the top opening of said basin-shaped casing through said tightening mechanism, and wherein a pulling lock is provided on one side of said barrel-shaped cloth cover, thus forming said clothes drying chamber.

7. The safe clothes drying machine, as recited in claim 2, wherein said fan chamber is disposed on the bottom exterior of said basin-shaped casing of said fan chamber for generating heated air, wherein said air inlet on the bottom of said basin-shaped casting is optimally placed in the middle of the bottom of said casing; wherein said fan chamber comprises a fan, a heat-resistant exhaust canopy disposed on an outer shell of said fan, a heating element between said exhaust canopy and said fan, and a filter placed in said shell of said fan corresponding to the position of blades of said fan.

8. The safe clothes drying machine, as recited in claim 2, wherein an exhaust canopy or exhaust grating is disposed on said air inlet at the bottom of said basin-shaped casing, wherein a water guarding protruding ring is disposed around the bottom canopy of said basin-shaped casing, wherein water drains are disposed at the bottom of said basin-shaped casing away from said canopy, so as to drain water from said machine after hanging clothes from said washing machine in said clothes drying chamber.

9. The safe clothes drying machine, as recited in claim 8, wherein the exhaust canopy, which is a column-shaped horizontal exhaust canopy, protrudes from the bottom of said casing, wherein the column-shaped horizontal exhaust canopy has a cylindrical shaped body with a sealed top and a plurality of exhaust ports formed at the surrounding wall of said body, wherein each of said exhaust ports has a horizontal current guiding board, or said exhaust canopy is a hemispherical exhaust canopy, said hemispherical shell of said exhaust canopy having multiple horizontal, vertical, or spiral exhaust ports, wherein a current guiding board having a corresponding shape is provided at each said exhaust port, wherein an umbrella-shaped water guard is provided at the top side of said exhaust canopy, wherein said umbrella-shaped water guard has an outer diameter slightly larger than the projection of said exhaust canopy.

10. The safe clothes drying machine, as recited in claim 8, wherein said exhaust canopy is a grating disposed on said air inlet at the bottom of said casing.

11. The safe clothes drying machine, as recited in claim 8, wherein said current guide safety cover is made of a heat-resistant plastic or metal board, said current guide safety cover having a plurality of fine ventilating holes evenly distributed on the surface, said ventilating holes having an area of 0.5 mm² to 100 mm², the ratio area of said ventilating holes to the area of said current guide safety cover being 1:20 to 1:0.5; wherein said current guide safety cover is affixed to the top opening of said basin-shaped casing by a pressure ring or screws or protrusions are disposed on the inner wall of said basin-shaped casing, wherein said current guide safety cover is affixed to said protrusions on the inner wall of said basin-shaped casing by a pressure ring or screws; wherein said ventilating holes evenly distributed on the surface of said current guide safety cover; or, said current guide safety cover has a non-holed zone, i.e. the area corresponding to said exhaust canopy is a non-holed zone, with a water channel disposed around said non-holed zone under said current guide safety cover, wherein said non-holed zone and water channel have an outer diameter slightly larger than said projection of said exhaust canopy so as to prevent the water dripped from the clothes in said clothes drying chamber from flowing into said fan chamber for generating heat.

12. The safe clothes drying machine, as recited in claim 1, further comprising a plurality of support legs disposed circumferentially under said basin-shaped casing of said warm air buffer chamber, said support legs being sufficiently long enough to suspendedly support said fan chamber for generating heated air above ground, each of said support legs having a leg wheel at an end, and said support legs being surrounded by a holed planer skirt; or further comprising a plurality of integral support legs disposed below said fan, each support leg having a leg wheel.

13. The safe clothes drying machine, as recited in claim 1, further comprising a humidity probe placed inside said clothes drying chamber and a temperature probe placed inside said warm air buffer chamber, said humidity probe and said temperature probe being electrically connected to said controller.

14. The safe clothes drying machine, as recited in claim 3, wherein said basin-shaped casing of said warm air buffer chamber is made of an air-tight double walled basin-shaped casing made of plastic or metal plating.
